(19) United States
(12) Patent Application Publication
(10) Pub. No.: US 2011/0080435 A1
(43) Pub. Date: Apr. 7, 2011

(54) IMAGE DISPLAY APPARATUS AND ELECTRONIC DEVICE COMPRISING SAME

(75) Inventor: Daisuke Sasaguri, Yokohama-shi (JP)

(73) Assignee: CANON KABUSHIKI KAISHA, Tokyo (JP)

(21) Appl. No.: 12/892,294

(22) Filed: Sep. 28, 2010

(30) Foreign Application Priority Data
Oct. 2, 2009 (JP) 2009-230402

(51) Int. Cl. G09G 5/10; H05B 37/02

(52) U.S. Cl. 345/690; 315/291

(57) ABSTRACT

An image display apparatus includes: a rear plate provided with a plurality of electron-emitting devices; a face plate having a plurality of pixels in each of which there is arranged a phosphor that emits light by being irradiated with electrons emitted by the electron-emitting devices; and a drive circuit that receives an image signal and drives the electron-emitting devices. The phosphor is a phosphor represented by general formula (I): MBO₃:Eu (wherein M denotes at least one of Y and Gd). The drive circuit drives the electron-emitting devices in such a manner that an upper limit of charge density injected to the pixels is equal to or greater than 5×10⁻⁸ (C/cm²) per one scan.

### BACKGROUND OF THE INVENTION

1. Field of the Invention

The present invention relates to an image display apparatus and an electronic device equipped with the image display apparatus.

2. Description of the Related Art

Conventional cathode ray tubes (CRTs) employ so-called P22 phosphors such as “ZnS:Cu, Al”, “ZnS:Ag, Cl”, “Y₂O₂S:Eu” and the like.

FIG. 5 is a schematic diagram of a conventional CRT. In the CRT, an electron beam 1202 emitted by one or three electrons guns 1203 scans the entirety of a screen 1201 that is coated with a phosphor, to elicit emission in the phosphor that forms the pixels. Pixels are formed over the screen 1201 in a periodic array. In each pixel, there are disposed a phosphor for R (red), a phosphor for G (green) and a phosphor for B (blue), collectively known as P22 phosphors for color CRTs. Although the charge density with which the electron beam irradiated by the electron gun strikes one pixel is small, sufficient brightness is achieved thanks to a high electron accelerating voltage.

However, a greater screen size in CRTs entails larger dimensions of the apparatus as a whole, which is a drawback in terms of, for instance, heavier weight. There is accordingly a growing demand for flat panel displays (FPDs) as lightweight image display apparatuses having a thin profile.

Examples of FPDs include, for instance, color liquid crystal displays, plasma displays and field emission displays (FEDs). In these displays, the image display portion (called image display panel or display panel) is shaped as a plate and the screen is flat, for which reason they are referred to as flat panel displays (FPDs). FEDs are field emission displays (image display apparatuses) the image display portion of which is called a FED panel.

Various FED types are being researched, for instance FED types that use Spindt electron-emitting devices, and surface-conduction electron-emitting devices, so-called SCEs. Herein, SCE is the acronym of surface-conduction electron emitter.

Those FEDs that employ SCEs as electron-emitting devices are called surface-conduction electron-emitting device displays (SEDs: surface-conduction electron emitter displays).

FEDs can be divided into low-voltage types, where the accelerating voltage is equal to or smaller than 1 kV, and high-voltage types in which the accelerating voltage ranges from about 1 to 10 kV. Conventional P22 phosphors for CRTs, or improved phosphors thereof, have often been used in FEDs where emission by the phosphor is elicited through acceleration of an electron beam using comparatively high voltage, as is the case in high-voltage FEDs.

For instance, Japanese Patent Application Laid-open No. H05-251023 discloses a phosphor for FEDs in the form of a conventional zinc sulfide phosphor in which the concentration of an activator has been optimized.

Also, Japanese Patent Application Laid-open No. 2004-158350 discloses red phosphors for FEDs in the form of, for instance, “Y₂O₃: Eu”, “Y₂O₂S:Eu”. “Y₃Al₅O₁₂:Eu”, “YBO₃:Eu”, “YVO₄:Eu”, “Y₂SiO₅:Eu”, “Y_{0.96}P_{0.60}V_{0.40}O₄:Eu_{0.04}”, “(Y, Gd)BO₃:Eu”, “GdBO₃:Eu”, “ScBO₃:Eu”, “3.5MgO0.5MgF₂.GeO₂:Mn”, “Zn₃ (PO₄)₂: Mn”, “LuBO₃:Eu”, “SnO₂:Eu” or the like.

Y₂O₂S:Eu is a known P22 red phosphor. However, detailed assessment of field emission displays (FEDs) that use Y₂O₂S:Eu has shown that a greater injected charge density is accompanied by a significant drop in the emission efficiency of red phosphors, which precludes achieving display with sufficiently high brightness.

At the same time there occurs the problem of white balance offset, caused by rises in temperature in fluorescent screens, when the rate of brightness change that accompanies rises in temperature varies significantly among phosphors, upon formation of a full-color image by combining a red phosphor with a green phosphor and a blue phosphor. High-reliability FEDs cannot be obtained in such cases.

The electron accelerating voltage in FED panels is lower than in CRTs. In order to achieve brightness comparable to that of CRTs, therefore, the phosphor must emit light by being excited with a greater current (more accurately, with a greater injected charge density per sub-pixel per one scan).

Therefore, the amount of charge that is injected simultaneously is far higher than in CRTs in the case of using a FED panel fluorescent screen, which exhibits greater rises in temperature than CRTs, in particular when employing passive matrix driving. In such cases, the drop in brightness on account of rising temperature (thermal quenching) constitutes a problem that cannot be overlooked. Increasing charge density in order to make up for the drop in brightness places a greater burden on the phosphor. The phosphor may deteriorate and the life thereof be shortened, all of which is problematic.

### SUMMARY OF THE INVENTION

In the light of the above problems, it is an object of the present invention to provide a highly reliable electron beam excitation-type image display apparatus that affords high brightness, through the use a phosphor optimized for driving conditions in electron beam excitation-type image display apparatuses.

The present invention in its first aspect provides an image display apparatus, including: a rear plate provided with a plurality of electron-emitting devices; a face plate having a plurality of pixels in each of which there is arranged a phosphor that emits light by being irradiated with electrons emitted by the electron-emitting devices; and a drive circuit that receives an image signal and drives the electron-emitting devices, wherein the phosphor is a phosphor represented by general formula (I): MBO₃:Eu (wherein M denotes at least one of Y and Gd), and the drive circuit drives the electron-emitting devices in such a manner that an upper limit of charge density injected to the pixels is equal to or greater than 5×10⁻⁸ (C/cm²) per one scan.

The image display apparatus according to the present invention can be installed, as an image display unit, in various electronic devices.

The present invention affords an electron beam excitation light-type image display apparatus wherein the use of a specific red phosphor allows selecting electron beam irradiation under conditions of high charge density, equal to or greater than 5×10⁻⁸ C/cm² per one scan. High brightness with no white balance fluctuation in displayed white image is achieved as a result.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of an image display apparatus according to the present invention;

FIG. 2A and FIG. 2B are plan-view partial diagrams illustrating examples of the structure of a fluorescent screen, wherein FIG. 2A illustrates a stripe-like pixel arrangement and FIG. 2B illustrates a delta-like pixel arrangement;

FIG. 3A is a diagram illustrating an example of the structure of an electron-emitting device, FIG. 3B is a cross-sectional schematic diagram of an example of an FED panel, and FIG. 3C is a diagram illustrating a connection example between electron-emitting devices and signal lines and scan lines;

FIG. 4 is a cross-sectional schematic diagram of an example of an FED panel;

FIG. 5 is a cross-sectional schematic diagram of a conventional CRT; and

FIG. 6 is a schematic diagram of an example of an electronic device that uses the image display apparatus of the present invention.

### DESCRIPTION OF THE EMBODIMENTS

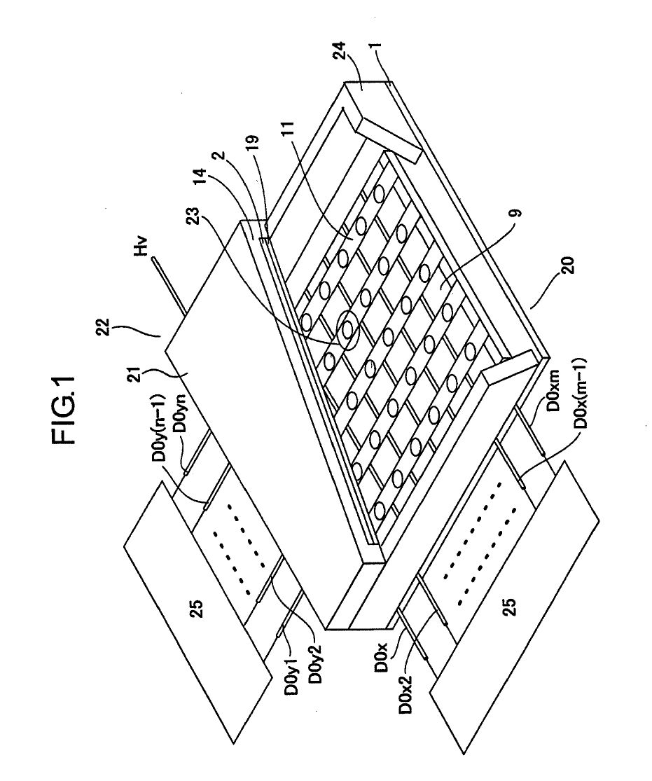

Embodiments of the present invention are explained next. FIG. 1 illustrates an example of a field emission-type display (FED) that is used for building up an electron beam excitation-type image display apparatus. The FED comprises at least an FED panel 22 and drive circuits 25.

The FED panel 22 has a structure such that a face plate 21, in which a fluorescent screen 2 is formed, is joined, by way of a side wall 24, to a rear plate 20 on which electron-emitting devices (not shown) are formed. The above members are sealed at a bonding portion. The inner space formed by the above members is evacuated down to about 10⁻⁵ Pa or less. A member called a spacer is inserted, according to the size of the screen, in order to preserve a given distance between the face plate 21 and the rear plate 20.

The rear plate 20 has a rear-side substrate 1 comprising glass or the like; electron-emitting devices (not shown) disposed on an insulating face of the rear-side substrate 1; and a plurality of signal lines 9 and a plurality of scan lines 11 that make up the wiring for inputting electric signals into the electron-emitting devices. The scan lines 11 and signal lines 9 have mutually intersecting portions 23. An insulating layer (not shown) is sandwiched between the signal lines 9 and the scan lines 11 at each intersection portion 23. The plurality of signal lines 9 and plurality of scan lines 11 are thus electrically insulated from each other in the above structure, so that electric signals can be applied selectively to respective signal lines and scan lines. An electron-emitting device (not shown) is formed at each intersection portion 23.

Terminals D0x1 to D0xm are terminals for externally applying voltage to the signal lines 9, and terminals D0y1 to D0yn are terminals for externally applying voltage to the scan lines 11. A set of mutually perpendicular wirings such as that of the signal lines 9 and scan lines 11 is referred to as matrix wiring. The wiring can configured in various ways, for instance by using the wiring connected to the terminals D0x1 to D0xm as scan lines, and the wiring connected to the terminals D0y1 to D0yn as signal lines.

The face plate 21 has a face-side substrate 14 comprising glass or the like, a fluorescent screen 2 provided in an image display portion of the face-side substrate 14, and a metal back 19 that covers the fluorescent screen 2. A high-voltage terminal Hv is connected to the metal back 19. In the above configuration, the metal back 19 functions as an anode.

The signal lines 9 and scan lines 11 provided in the rear plate 20 are connected to the drive circuits 25. An image signal is inputted to the drive circuits 25. On the basis of the inputted image signal, the drive circuits 25 apply electric signals (voltage), corresponding to the image signal, to the signal lines 9 and the scan lines 11. Voltage applied to the metal back 19, which functions as an anode, causes accelerating voltage to be applied between the rear plate 20 and the face plate 21. Electric signals corresponding to the above-described image signal are applied to the electron-emitting devices formed at respective intersection portions 23, whereupon electron beams are emitted from the devices. The electron beams emitted by the electron-emitting devices pass through the metal back 19 and strike the phosphor disposed on the fluorescent screen 2. The phosphor is excited and emits light as a result. The obtained fluorescent light traverses the light-transmissive face of the face-side substrate 14, and is emitted outwards. An image is formed as a result on the FED panel 22.

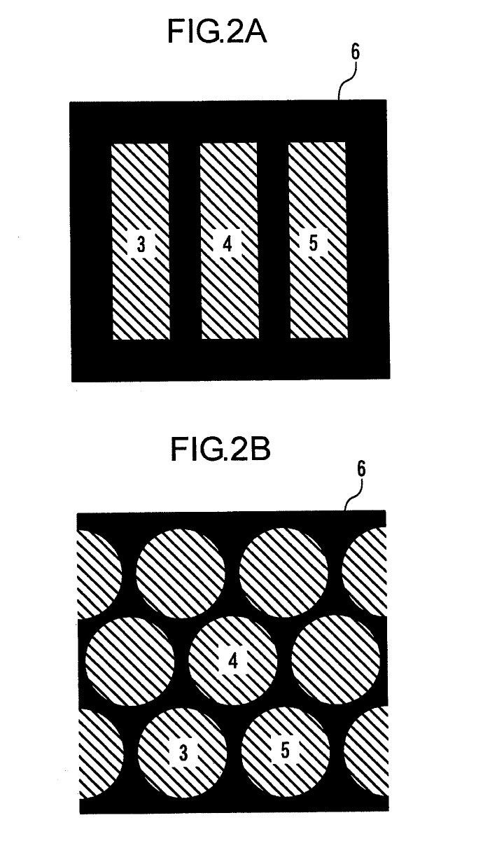

FIG. 2A and FIG. 2B illustrate enlarged plan-view diagrams of part of the fluorescent screen 2, viewed from the rear plate 20. An example of the configuration of the fluorescent screen will be explained with reference to FIG. 2A and FIG. 2B. Color display is ordinarily achieved by forming pixels of three colors red (R), green (G) and blue (B). The example explained herein refers therefore to the three colors R, G and B.

In case of display using a single color, the phosphor may be selected in such a manner that fluorescent light of the same color is obtained from each pixel.

The fluorescent screen 2 illustrated in FIG. 2A and FIG. 2B has pixels 3, 4, 5 on which a phosphor is disposed, and a black portion 6 that partitions the pixels. As illustrated in FIG. 2A and FIG. 2B, the phosphor pixels 3, 4, 5 are preferably surrounded by the black portion 6, in order to prevent intrusion of electron beams between adjacent pixels even if the irradiation position of the electron beam is slightly offset, and in order to improve display contrast by preventing reflection of external light. The material used for forming the black portion 6 may be a material having typically graphite as a main component, but may be any other material.

In FIG. 2A, the three pixels, namely a pixel 3 comprising a red phosphor, a pixel 4 comprising a blue phosphor, and a pixel 5 comprising a green phosphor are arrayed at stripe-like openings formed in the black portion 6. In the present invention, the term “pixel” denotes the smallest unit region at which a phosphor is disposed. The set of cells of three colors, red blue and green, as the smallest units, is referred to as a pixel, and each red, blue and green cell is also referred to as a sub-pixel. The “pixel” in the present invention corresponds to the sub-pixel in the example illustrated in FIG. 2A.

The surface area of one pixel is decided in accordance with the number of pixels and the size of the display. A black portion 6 in which there are partitioned pixels arrayed in the form of a matrix is referred to as a black matrix. The pixels 3, 4, 5 can be formed by known methods, for instance, screen printing, using an ink comprising a phosphor and a binder, and an ink comprising a black material and a binder.

The layout of the pixels 3, 4, 5 is not limited to the stripe-like array illustrated in FIG. 2A, and may take on other forms, such as the delta-like arrangement illustrated in FIG. 2B.

As the electron-emitting devices disposed at the intersection portions 23 between the signal lines 9 and the scan lines 11 there can be used, for instance surface conduction-type electron-emitting devices (SCE), Spindt-type field emission devices, MIM-type electron-emitting devices, or devices having emitting portions of carbon nanotubes (CNTs). Surface-conduction electron-emitting devices, which can be easily manufactured as electron-emitting devices capable of irradiating a charge density of at least 5×10⁻⁸ C/cm² per pixel, can be suitably used, in particular, as the electron-emitting devices of the image display apparatus of the present invention.

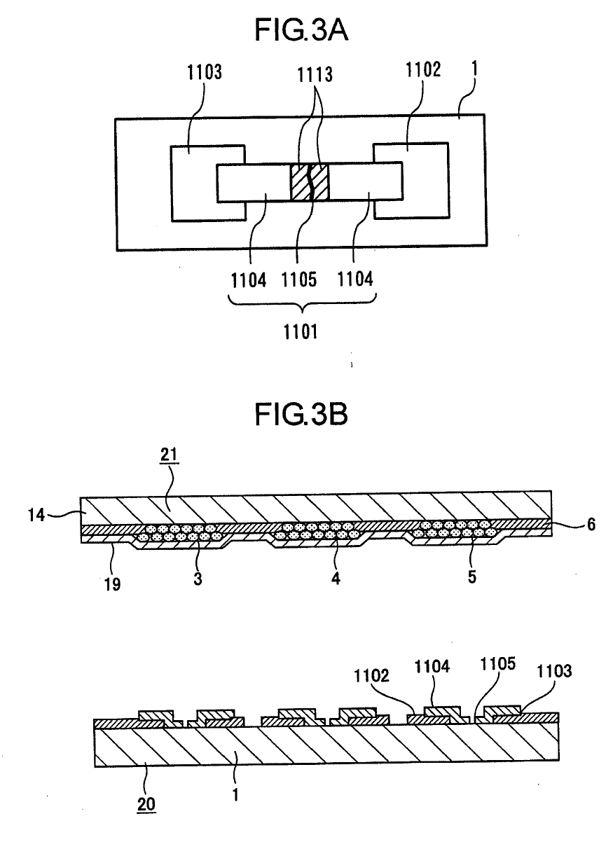

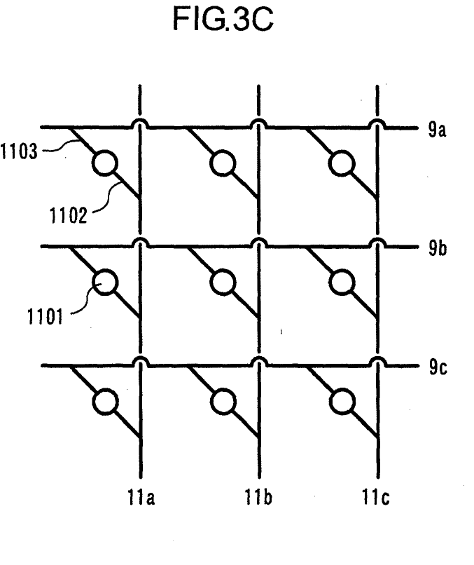

FIG. 3A is a plan-view diagram of an SCE, and FIG. 3B is a cross-sectional diagram of an FED panel that uses an SCE. As illustrated in FIG. 3A and FIG. 3B, an SCE 1101 disposed on the rear-side substrate 1 of the rear plate 20 comprises device electrodes 1102, 1103, a conductive film 1104, an electron-emitting portion 1105, and a thin film 1113 (not shown in FIG. 3B). The device electrodes 1102, 1103 are formed spaced apart from each other, across a predetermined spacing, on the rear-side substrate 1. The conductive film 1104 is provided at positions at which the conductive film 1104 covers the ends of the device electrodes and covers the portions between these ends. The electron-emitting portion 1105 is provided in the vicinity of that intermediate portion. The thin film 1113 (not shown in FIG. 3B) is formed at a region that encompasses the electron-emitting portion 1105. The electron-emitting portion 1105 is formed by an activation process.

On the face-side substrate 14 of the face plate 21 a fluorescent screen 2 is formed on which there are disposed red pixels 3, blue pixels 4 and green pixels 5 within a black portion 6 that comprises a black member such as graphite or the like. The pixels 3, 4, 5 are arranged for instance according to the arrangement illustrated in FIG. 2A and FIG. 2B. A metal back 19 is further formed on the fluorescent screen 2 so as to cover it.

In the example illustrated in the figures, the metal back 19, to which high voltage is applied, is used as an anode. The metal back 19 may also function as a getter. In the latter case there can be used a metal back having a two-layer structure that comprises an anode layer, on the side of the phosphor, and a getter functional layer on the side opposite the electron-emitting devices. The face plate is not limited to the configuration of the example illustrated in the figure, and may be embodied in other various ways.

The face plate 21 and the rear plate 20 are joined in such a manner that pixels on the side of the face plate 21 oppose respective electron-emitting devices on the side of the rear plate 20.

The device electrodes 1102 and 1103 are provided on the rear-side substrate 1 so as to be parallel to the surface of the rear-side substrate 1. For instance, each device electrode 1102 is connected to a signal line 9 and each device electrode 1103 is connected to a scan line 11. Potential is supplied to the device electrodes 1102 and 1103 by way of the above respective wirings, whereupon electrons are emitted from the electron-emitting portion 1105.

FIG. 3C illustrates an example of the connections of electron-emitting devices 1101 to wirings. As illustrated in FIG. 3C, each electron-emitting device 1101 can be driven selectively by connecting the device electrodes 1102 to scan lines 11 (11a to 11c) and connecting the device electrodes 1103 to signal lines 9 (9a to 9c). That is, potential is supplied to the device electrodes 1102 and 1103 by way of the wirings of the signal lines 9 and scan lines 11, whereupon electrons are emitted from each electron-emitting portion 1105.

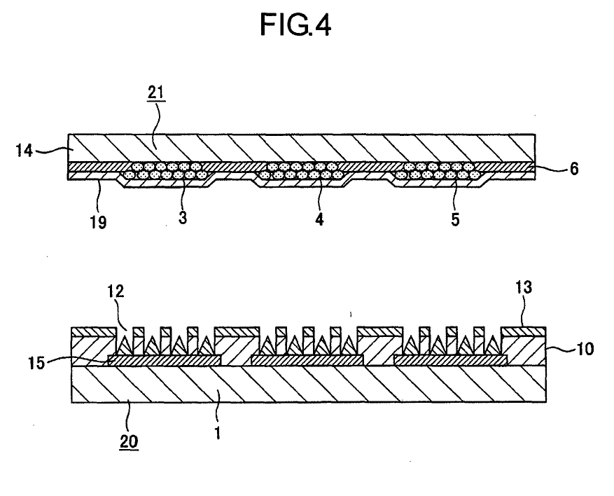

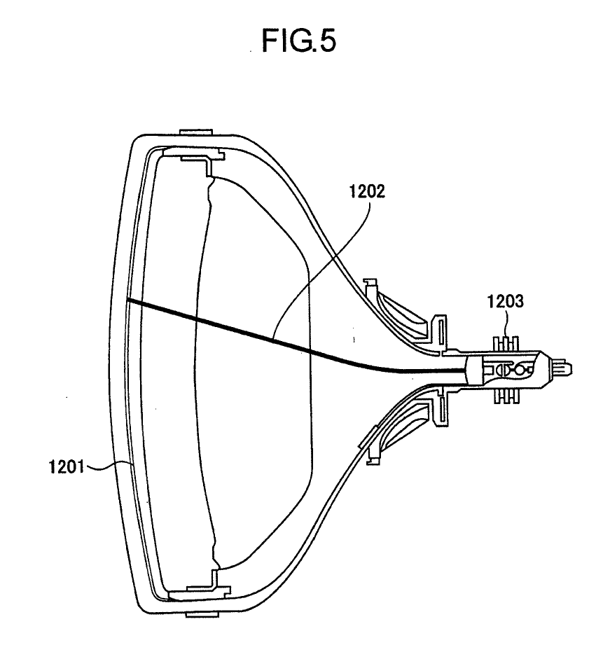

FIG. 4 is a cross-sectional schematic diagram of a FED panel that uses electron-emitting devices in the form of Spindt devices. The configuration of the face plate 21 is identical to that explained for FIG. 3B.

The Spindt electron-emitting devices provided in the rear plate 20 have each an electron emitting member 12 of a conical protrusion, an insulating layer 10 formed so as to surround the electron emitting member 12, and a gate electrode 13 provided on the insulating layer. The electron-emitting devices are provided at positions opposing respective pixels on the side of the face plate 21. Each electron-emitting member 12 is formed on an electrode 15. The electrode 15 is connected to a signal line 9 and the gate electrode 13 is connected to a scan line 11. The electron-emitting device is connected thereby to the drive circuits.

The phosphor for forming the pixels is explained next.

In the present invention there is at least used the phosphor represented by general formula (I): MBO₃:Eu (wherein M denotes at least one of Y and Gd), as a red phosphor.

As a green phosphor there is preferably used a ZnS:Cu, Al or a thiogallate crystal containing an alkaline earth metal and doped with Eu luminescent centers. As the blue phosphor there is preferably used, for instance, ZnS:Ag, Cl or ZnS:Ag, Al.

Green phosphors such as ZnS:Cu, Al or a thiogallate crystal containing an alkaline earth metal and doped with Eu luminescent centers, as well as blue phosphors such as ZnS:Ag, Cl or ZnS:Ag, Al, have emission characteristics such that the emission efficiency of the phosphor virtually does not change with rising temperature.

Red phosphors represented by general formula MBO₃:Eu have emission characteristics such that the emission efficiency of the phosphor virtually does not change with rising temperature, as in the case of the above-mentioned blue phosphors and green phosphors. As a result, excellent light emission characteristics can be achieved also in electron-beam excitation displays in which a fluorescent screen is excited at a high charge density.

However, phenomena such as fusion of the fluorescent screen, and accelerated degradation of the screen may occur if excessively high charge density is injected. Therefore, the upper limit of charge density is preferably set at 3×10⁻⁶ C/cm².

A thorough assessment of such phenomena revealed that high emission efficiency, higher than that of the P22-type phosphor Y₂O₂S:Eu, which is a widely used phosphor material for electron beams, can be achieved by using the above-described red light-emitting material resulting from combining a specific host material and a specific luminescent center material. The high emission efficiency of the red phosphor becomes manifest also in an image display apparatus that allows selecting a mode wherein a charge density equal to or greater than 5×10⁻⁸ C/cm² can be injected into a phosphor. Specifically, it is preferable that one driving condition of the electron-emitting devices is set beforehand in such a manner that the charge density injected to pixels based upon the received image signal is at least 5×10⁻⁸ (C/cm²) per one scan, and that the drive circuit used can be driven with the driving condition. High-brightness and high-resolution image display can be realized by combining the above red phosphor and electron irradiation at high charge density.

The phosphor represented by general formula (I) is, preferably, “YBO₃:Eu”, “GdBO₃:Eu”, “(Y, Gd)BO₃:Eu” or the like.

As used herein, the terms green, blue and red denote typically the following CIE (x, y) chromaticity coordinates:

Green (x, y)=(0.15≦x≦0.35, 0.5≦y≦0.85)

Blue (x, y)=(0.05≦x≦0.25, 0≦y≦0.2)

Red (x, y)=(0.5≦x≦0.73, 0.2≦y≦0.4)

(Red, blue and green refer to the visible region within the above ranges.)

For instance, “ZnS:Cu, Al (green)”, “ZnS:Ag, Cl (blue)”, “ZnS:Ag, Al (blue)”, “SrGa₂S₄:Eu (green), which is a thiogallate crystal comprising an alkaline earth metal and doped with Eu as a luminescent center material”, and “(Sr₁₋ₓ, Baₓ)Ga₂S₄:Eu (green)”, may be used in green phosphors and blue phosphors in phosphor combinations, from the viewpoint of light emission efficiency and in consideration of changes in brightness characteristics arising from changes in temperature. As described below, x ranges preferably from 0≦x≦0.3. The term thiogallate denotes a compound comprising Ga and S.

In particular, a reproducible color gamut superior to that of ZnS:Cu, Al (green) can be achieved, with high light emission efficiency and durability towards electron beams, by using “SrGa₂S₄:Eu (green)” or “(Sr₁₋ₓ, Baₓ)Ga₂S₄:Eu (green) in which some Sr atoms are replaced by Ba”, from among the above phosphors.

The above (Sr₁₋ₓ,Baₓ)Ga₂S₄:Eu changes from green to blue-green as the Sr:Ba ratio changes. The composition ratio between Sr and Ba can be appropriately designed as the case may require, in order to achieve light emission truer to NTSC green than that of SrGa₂S₄:Eu.

When (Sr₁₋ₓ, Baₓ)Ga₂S₄:Eu is used as the green phosphor, the composition ratio is selected from the range 0≦x≦0.3, more preferably from the range 0≦x≦0.25.

The phenomenon of concentration quenching, in the form of a drop in phosphor brightness, occurs when the luminescent center material is doped to an excessive concentration. Actually, an optimal luminescent center concentration can be selected from within a luminescent center concentration range such that sufficient brightness is obtained upon a change in emission brightness after a peak at a certain luminescent center concentration.

As regards the luminescent center concentration, the number of Eu atoms and the number of Sr atoms (or sum of Sr plus Ba atoms) is preferably 0.001≦Eu/Sr (or Eu/(Sr+Ba))≦0.1 in the case of SrGa₂S₄:Eu or (Sr₁₋ₓ, Baₓ)Ga₂S₄:Eu.

The optimal value of luminescent center concentration can be selected in accordance with the emission efficiency of other phosphors that are combined, provided that the range 0.001≦Eu/Sr≦0.1 is satisfied.

The light emission characteristics required from the blue phosphor must be evaluated according to an index that is decided on the basis of the color temperature of white, as the reference for display, the light emission efficiency of the phosphor of each color, and the balance between color coordinates. Performance in terms of, for instance, changes in brightness depending on color, emission efficiency and color temperature, must also be taken into account.

In the light of the above index, the blue phosphor is preferably “ZnS:Ag, Cl”, “ZnS:Ag, Al” or a “phosphor of a silicate crystal, containing an alkaline earth metal or the like, doped with Eu as a luminescent center material”.

The various pixels 3, 4, 5 can be formed, in the form of a film (layer), by arranging particles of a phosphor, milled to a uniform particle size, onto predetermined positions using a binder or the like as the case may require. Many phosphors have high resistance, and hence the optimal particle size of the phosphor is preferably selected depending on the accelerating voltage of the electrons and on the configuration of the face plate. Although the optimal particle size varies depending on the penetration length of the irradiated electrons, the average particle size can be typically selected from a range of not less than 0.5 lam and not more than 15 μm. In terms of electric charging, the average particle size is preferably not less than 1 not more than 5 μm. The amount of phosphor contained in the pixels is adjusted in such a manner so as to achieve the intended emission color and intended brightness.

The metal back 19 of the example in the figures, which functions as an anode to which high voltage is applied, has also the function of preventing charging of the phosphor. The material that makes up the metal back 19 may be a conductive metallic material such as Al or the like, although a getter material for absorbing oxygen or the like may also be overlaid on the conductive metallic material such as Al. When a getter material is used in the metal back 19, any gas carried in the small flow of external air that may get into the sealed space between the face plate 14 and the rear plate 20 can become adsorbed onto the getter material. The airtight state can be preserved thereby for long periods of time. The getter material that can be used may comprise, for instance, Ti, Zr, Ba or an alloy having at least one of the foregoing as a main component. These alloys may contain, as auxiliary components, one or more elements from among Al, V and Fe. Optimal values of the thickness of the metal back 19 and the thickness of getter material can be selected depending on the electron accelerating voltage. The metal back 19 may be formed from a layer that comprises a getter material and is also conductive.

In the image display apparatus having the configuration illustrated in FIG. 1 a plurality of electron-emitting devices is selectively driven by the drive circuits 25 that have received an image signal, whereby the pixels corresponding to the driven electron-emitting devices emit fluorescent light, and an image is displayed as a result. In the case of full-color display, as described above, a fluorescent screen is formed on the face plate 21, such that pixels of three colors, for instance red, blue and green are disposed on the fluorescent screen. Images are formed by controlling the amount of irradiated charge in accordance with an input signal. Ordinarily, for instance, the metal back 19 is formed on the fluorescent screen 2 of the face plate 21, as a means for preventing charging of the phosphor. If the acceleration energy is low (low accelerating voltage), the energy is dissipated by the metal back 19, and sufficient brightness cannot be achieved.

In FED panels, moreover, voltage is applied across a narrow space of several mm. This may give rise to problems such as discharge or the like if an excessively high voltage is applied.

In the light of the above, a voltage ranging preferably from 7 kV to 15 kV is applied to the anode, and the accelerating voltage of the electrons is preferably set not less than 7 kV and not more than 15 kV, in order to achieve sufficient brightness and definition in the display image. Sufficient brightness can be achieved when the electron accelerating voltage is equal to or greater than 7 kV, while problems such as discharge or the like can be averted when the electron accelerating voltage is equal to or smaller than 15 kV.

The drive circuits 25 are configured in such a manner that it is possible to select driving conditions that allow irradiating electrons, from the electron-emitting devices, at a charge density of at least 5×10⁻⁸ C/cm² per one scan onto the phosphor in each pixel. That is, there is set a charge density equal to or greater than 5×10⁻⁸ C/cm² as the charge density that is irradiated onto the pixels, such that the drive circuits 25 elicit irradiation onto the pixels at the set charge density per one scan, at an image portion for which sufficient brightness must be secured, over the corresponding display time.

One scan denotes herein the process of scanning all the scan lines required for forming one screen. For instance, one scan denotes the process whereby scan signals are inputted to all the scan lines 11 in the case of matrix driving using the matrix wiring illustrated in FIG. 1, where all the plurality of scan lines 11 that make up the matrix wiring are used for forming one screen. Selective driving of the respective electron-emitting devices connected to the scan line 11 is performed through selection of the signal lines 9.

Examples of image display methods include, for instance, progressive scanning and interlace scanning. In progressive scanning, one image (for instance, one frame) is displayed through sequential scanning of scan lines. In interlace scanning, scan lines are divided into even and odd lines that are interlaced by being scanned in succession. As a result, each frame is divided into two fields, each of which is scanned in turn. In interlace scanning, the term “one scan” as used in the present invention corresponds to the process whereby one field is scanned.

An example of progressive scanning is explained with reference to FIG. 3C. In a one-scan process, scan signals are successively inputted to the scan lines 11a to 11c, to display one screen (frame) by way of scan lines 11a to 11c. The one scan process is over once the scan signals have been inputted to all the scan lines.

The driving method used may be, for instance, passive matrix driving with a refresh frequency of 60 Hz and an irradiation time duty cycle equal to or smaller than 1/240.

Instead of being set to a charge density of at least 5×10⁻⁸ C/cm² at all times, the drive circuits 25 are configured in such a manner that there can selected a charge density lower than 5×10⁻⁸ C/cm², in accordance with image information.

The electron-emitting devices having the structure illustrated in, for instance, FIG. 3A to FIG. 3C and FIG. 4 can be used as electron-emitting devices that permit irradiation of a charge density equal to or greater than 5×10⁻⁸ C/cm² per one scan.

An explanation follows next on an example of driving conditions upon display of an image made up of pixels, each of which comprises sub-pixels of three colors.

In a case where the effective scan line number P is 1080 lines and the frame frequency F is 60 Hz, the maximum value of the time T over which a signal can be applied to one scan line per one scan is 1/(F·P), about 15 μsec.

The charge density Q (C/cm²) injected per unit surface area, for a current density Je of 3.3 mA/cm² irradiated per each sub-pixel, is given by Je×T, which yields about 5×10⁻⁸ C/cm² in the above example.

As the above relationship suggests, the maximum value of the application time T is limited by the number of scan lines P and the frequency F. Therefore, the time T is lengthened if the number of scan lines is, for instance 768 lines.

Actually, the maximum time T is decided taking into account, for instance, delay caused by wiring resistance and delay in the driving devices. The maximum time T is often shorter than 15 μsec in cases where the number of scan lines P is 1080 lines. Methods for varying the display brightness involve, for instance, modifying the above-mentioned application time T, modifying the current density J, or modifying both the application time T and the current density J.

In the present invention there is used at least a red phosphor represented by general formula (I), as the phosphor that makes up the pixels. Also, driving conditions can be selected so that the charge density of the electron beam irradiated onto the pixels is at least 5×10⁻⁸ C/cm² per one scan. Image display by the drive circuit under the above conditions allows realizing high-brightness display at image portions where high brightness is required, and allows obtaining excellent color balance unaffected by temperature changes.

The image display apparatus according to the present invention can be ordinarily used in electronic devices having a display portion where image signals are rendered into images. Examples of such electronic devices include, for instance, television sets, integral personal computers and the like.

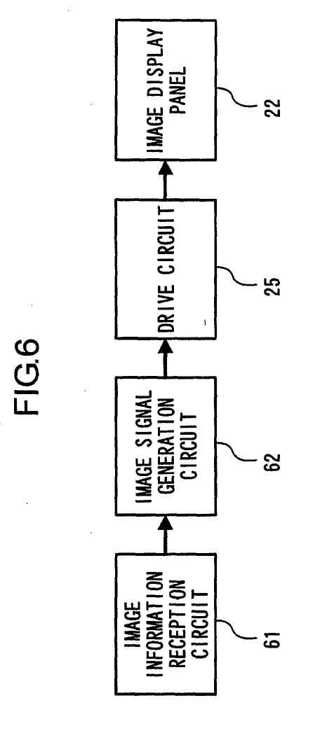

FIG. 6 is a schematic diagram of an electronic device equipped with the image display apparatus of the present invention. This electronic device receives image information by wireless broadcasting, cable broadcasting, the internet or the like, and renders that image information in the form of an image on the image display apparatus. In FIG. 6, the reference numeral 61 denotes an image information reception circuit, 62 denotes an image signal generation circuit, 25 denotes a drive circuit and 22 denotes an image display panel. The image display apparatus according to the present invention comprises the drive circuit 25 and the image display panel 22.

The image information supplied by way of lines such as wireless broadcasting, cable broadcasting, the internet or the like may be modulated and also optionally encoded by compression, encryption or the like. The image information reception circuit 61 selects desired image information from among the plurality of image information items supplied from the line. The image information selected by the image information reception circuit 61 is demodulated and decoded by the image signal generation circuit 62, to yield an image signal.

On the basis of the supplied image signal, the drive circuit 25 supplies a signal for display to the image display panel 22. An image is then displayed on the image display panel 22, on the basis of the signal supplied by the drive circuit 25.

No decoding is carried out when the image information is not encoded.

When an image is to be displayed on the image display apparatus on the basis of information on a recording medium in which the image information is recorded, the image information recorded on the recording medium is read by a reading circuit (not shown) that reads image information from the recording medium. If the read image information is encoded, the image information is decoded by the image signal generation circuit 62, to yield an image signal. The obtained image signal is supplied to the drive circuit 25. On the basis of the supplied image signal, the drive circuit 25 supplies a signal for display to the image display panel 22. An image is then displayed on the image display panel 22, on the basis of the signal supplied by the drive circuit 25.

If the read image information is not encoded, the read image information and the image signal are the same. The read image signal is supplied to the drive circuit 25. On the basis of the supplied image signal, the drive circuit 25 supplies a signal for display to the image display panel 22. An image is then displayed on the image display panel 22, on the basis of the signal supplied by the drive circuit 25.

### EXAMPLES

The present invention will be explained in detail below based on concrete examples.

### Example 1

There was produced a face plate that used a (Y, Gd)BO₃:Eu phosphor (average particle size 3 μm). The face plate has the structure illustrated in FIG. 1, FIG. 2A and FIG. 3B (herein, though, only one type of phosphor is used).

The face plate is produced as follows. Firstly, a black matrix was coated, in the form of stripes, onto a glass substrate, leaving regions on which the phosphor is to be coated. A paste comprising phosphor particles and an organic binder was applied next, by screen printing, to form a phosphor paste layer at the opening portions of the black matrix, and the whole was then dried. A filming process was carried out next. In the filming process, an acrylic resin was applied and the resulting fluorescent screen was smoothed. Thereafter, there was formed a 100 nm-thick film of Al as a metal back. After formation of the metal back, the whole was fired at 450° C. in the atmosphere, to remove the acrylic resin.

A rear plate having electron-emitting devices formed thereon was produced next. The structure of the electron-emitting devices is as illustrated in FIG. 3A and FIG. 3B. Otherwise, the structure of the rear plate is as illustrated in FIG. 1.

To manufacture the rear plate, matrix wiring was formed by screen printing on a glass substrate, and then surface-conduction electron-emitting devices were formed at the wiring intersection portions. Signal lines and scan lines were connected to respective device electrodes in the pair of device electrodes that made up each electron-emitting device. The effective signal line number was 1920 lines, and the effective scan line number was 1080 lines.

The face plate and the rear plate manufactured as described above were disposed opposing each other in such a manner that pixels and respective electron-emitting devices were disposed at positions corresponding to each other. The resulting interior space was deaerated to a predetermined degree of vacuum. The signal lines were connected to the electron-emitting devices on the rear plate and the scan lines were connected to the drive circuits, to build the image display apparatus. A 10 kV DC voltage was applied across the above plates, using the metal back provided on the face plate as an anode. In this state, the drive circuit applied a pulse voltage to the matrix wiring of the rear plate, in such a way so as to elicit electron emission, and the resulting brightness was measured.

The driving method used was passive matrix driving with a refresh frequency of 60 Hz.

For comparison purposes, a face plate was produced in accordance with the same manufacturing process, but using Y₂O₂S:Eu as the phosphor, and brightness was measured under the same conditions as above.

The observed values of brightness 10 minutes after lighting were compared.

Table 1 sets out relative brightness values, taking 100 as the brightness upon irradiation of 5×10⁻⁸ C/cm² of charge density onto each pixel per one scan, using Y₂O₂S:Eu.

TABLE 1
Emission brightness relative comparison

| | Injected charge density | | | |
|---|---|---|---|---|
| | 1 × 10⁻⁸ | | 1 × 10⁻⁷ | |
| Phosphor | C/cm² | 5 × 10⁻⁸ C/cm² | C/cm² | 5 × 10⁻⁷ C/cm² |
| (Y, Gd)BO₃:Eu | 22 | 105 | 180 | 945 |
| Y₂O₂S:Eu | 25 | 100 | 160 | 850 |

Higher brightness was successfully realized in the display with (Y, Gd)BO₃:Eu, for irradiation at high charge density, as compared with the conventional Y₂O₂S:Eu.

### Example 2

An image display apparatus was produced in the same way as in Example 1, but using YBO₃:Eu as the phosphor, and with the effective signal line number set to 1366 lines and the effective scan line number set to 768 lines.

A 12 kV DC voltage was applied between the face plate and the rear plate as in Example 1. In this state, the drive circuit applied a pulse voltage to the matrix wiring of the rear plate, in such a way so as to elicit electron emission, and the resulting brightness was measured.

The driving method used was passive matrix driving with a refresh frequency of 60 Hz.

For comparison purposes, a face plate was produced in accordance with the same manufacturing process, but using Y₂O₂S:Eu as the phosphor, and brightness was measured under the same conditions as above.

Table 2 sets out relative brightness values, taking 100 as the brightness upon irradiation of 5×10⁻⁸ C/cm² of charge density per one scan, in the case of Y₂O₂S:Eu.

TABLE 2
Emission brightness relative comparison

| | Injected charge density | | | |
|---|---|---|---|---|
| | 1 × 10⁻⁸ | | | |
| Phosphor | C/cm² | 5 × 10⁻⁸ C/cm² | 1 × 10⁻⁷ C/cm² | 5 × 10⁻⁷ C/cm² |
| YBO₃:Eu | 21 | 101 | 175 | 940 |
| Y₂O₂S:Eu | 25 | 100 | 160 | 850 |

Higher brightness was successfully realized in the display with YBO₂:Eu, for irradiation at high charge density, as compared with the conventional Y₂O₂S:Eu.

### Example 3

A face plate having the same configuration as that of Example 1 was produced.

To prepare a rear plate, matrix wiring was formed on a glass substrate, and Spindt-type electron-emitting devices illustrated in FIG. 4 were formed at the wiring intersection portions. Signal lines and scan lines were respectively connected to the electron-emitting members and gate electrodes of the electron-emitting devices.

An image display apparatus was produced in the same way as in Example 1 using the above face plate and rear plate. A 7 kV DC voltage was applied between the face plate and the rear plate, using the metal back of the face plate as an anode. In this state, a pulse signal is inputted to the matrix wiring by the drive circuit, to trigger emission by the phosphor.

For comparison purposes, a face plate was produced in accordance with the same manufacturing process, but using (Y, Gd)BO₃:Eu as the phosphor, and brightness was measured under the same conditions as above.

Table 3 sets out relative brightness values, taking 100 as the brightness upon irradiation of 5×10⁻⁸ C/cm² of charge density per one scan, for Y₂O₂S:Eu.

TABLE 3
Emission brightness relative comparison

| | Injected charge density | | | |
|---|---|---|---|---|
| | 1 × 10⁻⁸ | | 1 × 10⁻⁷ | |
| Phosphor | C/cm² | 5 × 10⁻⁸ C/cm² | C/cm² | 5 × 10⁻⁷ C/cm² |
| (Y, Gd)BO₃:Eu | 22 | 105 | 180 | 935 |
| Y₂O₂S:Eu | 25 | 100 | 160 | 850 |

The results show that higher brightness can be realized during high charge density irradiation by using (Y, Gd)BO₃:Eu, as compared with conventional Y₂O₂S:Eu.

### Example 4

An image display apparatus was produced in the same way as in Example 1 but using a GdBO₃:Eu phosphor as the red phosphor. Emission characteristics were evaluated under the same conditions as in Example 1. The results showed that irradiation with a charge density of 5×10⁻⁷ C/cm² per one scan resulted in excellent brightness characteristics, of comparable degree, both for (Y, Gd)BO₃:Eu and YBO₃:Eu.

### Example 5

ZnS:Cu, Al was used as a green phosphor, ZnS:Ag, Cl as a blue phosphor, and (Y, Gd)BO₃:Eu as a red phosphor. The phosphors of each color were disposed as illustrated in FIG. 2A and FIG. 3B, to form pixels. An image display apparatus for full-color display was produced in the same way as in Example 1, except for the above conditions. Then, 10 kV DC voltage was applied between the face plate and the rear plate, using the metal back of the face plate as an anode. In this state, the drive circuit applied a pulse voltage to the matrix wiring of the rear plate, to drive thereby the electron-emitting devices. The displayed image was evaluated in accordance with the method below.

Image Evaluation:

Images were evaluated under three conditions, namely charge density injected to the red phosphor per one scan of 1×10⁻⁸ C/cm², 5×10⁻⁸ C/cm² and 5×10⁻⁷ C/cm². Under each condition, the charge density irradiated onto the blue phosphor and the green phosphor was controlled in such a way so as to achieve 9300 K (Kelvin) standard white. The brightness of the white display portion thus obtained was measured. The same experiment was carried out using an image display apparatus having the same configuration, but using herein Y₂O₂S:Eu as the red phosphor. The various brightness values were compared relative to each other, taking 100 as the white brightness upon irradiation of a charge density of 5×10⁻⁸ C/cm² onto Y₂O₂S:Eu. The observed values of brightness 10 minutes after lighting were compared. The obtained results are given in Table 4.

TABLE 4
Emission brightness relative comparison

| | Injected charge density | | |
|---|---|---|---|
| Red Phosphor | 1 × 10⁻⁸ C/cm² | 5 × 10⁻⁸ C/cm² | 5 × 10⁻⁷ C/cm² |
| (Y, Gd)BO₃:Eu | 22 | 103 | 950 |
| Y₂O₂S:Eu | 25 | 100 | 700 |

A brightness of 950 was obtained under driving conditions of 5×10⁻⁷ C/cm² per one scan, when using (Y, Gd)BO₃:Eu as the red phosphor. Higher brightness was achieved thus as compared with the conventional case, for a same irradiated charge density.

White balance offset was evaluated next in accordance with the method below.

White display was carried out by determining the charge density injected to the blue and green phosphors in such a manner that 9300 K white was achieved upon injection of a charge density of 1×10⁻⁸ C/cm² to the red phosphor. The degree of white balance offset upon irradiation of a 5-fold and 50-fold charge density onto the phosphors of each color was evaluated on the basis of variations (Δx, Δy) in CIE (x, y) coordinates.

The absolute value of the variation when using a combination including conventional Y₂O₂S:Eu was (Δx, Δy)≈(0.007, 0.002), for an injected charge density per one scan equal to or greater than 5×10⁻⁸ C/cm². By contrast, excellent color balance with virtually no variation in color coordinates or color temperature for white display, irrespective of the injected charge density values, was achieved in phosphor combinations that included (Y, Gd)BO₃:Eu according to the present invention.

### Example 6

An image-forming apparatus for full-color display was produced in the same way as in Example 5, but using herein SrGa₂S₄:Eu as the green phosphor, ZnS:Ag, Al as the blue phosphor, and YBO₃:Eu as the red phosphor.

Image display was evaluated in the same way as in Example 5, but herein under application of 11 kV DC voltage between the face plate and the rear plate. The obtained results are given in Table 5.

TABLE 5
Emission brightness relative comparison

| | Injected charge density | | |
|---|---|---|---|
| Phosphor | 1 × 10⁻⁸ C/cm² | 5 × 10⁻⁸ C/cm² | 5 × 10⁻⁷ C/cm² |
| YBO₃:Eu | 23 | 110 | 1050 |
| Y₂O₂S:Eu | 25 | 100 | 700 |

A relative brightness value of 1050 was obtained in the present example for driving conditions of 5×10⁻⁷ C/cm² per one scan, using YBO₃:Eu as the red phosphor.

The degree of white balance offset was evaluated in the same way as in Example 5. The results showed a variation (Δx, Δy)≈(0.007, 0.002), when using a combination that included conventional Y₂O₂S:Eu. By contrast, excellent color balance with virtually no variation in color coordinates or color temperature in white display, irrespective of the injected charge density value, was achieved in phosphor combinations that included a phosphor according to the present invention.

A wide reproducible color gamut was achieved by using SrGa₂S₄:Eu as the green phosphor.

### Example 7

An image-forming apparatus for full-color display was produced in the same way as in Example 5, but using herein (Sr, Ba)Ga₂S₄:Eu as the green phosphor, ZnS:Ag, Al as the blue phosphor, and (Y, Gd)BO₃:Eu as the red phosphor.

Image display was evaluated in the same way as in Example 5, but herein under application of 10 kV DC voltage between the face plate and the rear plate. White balance offset was evaluated in the same way as above. In the image display apparatus of the present example there were obtained excellent emission characteristics virtually free of variation in color coordinates or color temperature in white display, and with high brightness, comparable to that in Examples 5 and 6.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-230402, filed on Oct. 2, 2009, which is hereby incorporated by reference herein in its entirety.

What is claimed is:

1. An image display apparatus, comprising:
a rear plate provided with a plurality of electron-emitting devices;
a face plate having a plurality of pixels in each of which there is arranged a phosphor that emits light by being irradiated with electrons emitted by the electron-emitting devices; and
a drive circuit that receives an image signal and drives the electron-emitting devices,
wherein the phosphor is a phosphor represented by general formula (I):MBO₃:Eu (wherein M denotes at least one of Y and Gd), and
the drive circuit drives the electron-emitting devices in such a manner that an upper limit of charge density injected to the pixels is equal to or greater than 5×10⁻⁸ (C/cm²) per one scan.

2. The image display apparatus according to claim 1,
wherein the face plate has an anode to which a voltage ranging not less than 7 kV and not more than 15 kV is applied.

3. The image display apparatus according to claim 1,
wherein the phosphor is (Y, Gd)BO₃:Eu or YBO₃:Eu.

4. The image display apparatus according to claim 1,
wherein the face plate further has a blue phosphor and a green phosphor,
the blue phosphor is ZnS:Ag, Al or ZnS:Ag, Cl, and
the green phosphor is ZnS:Cu, Al or a phosphor of a thiogallate crystal comprising an alkaline earth metal and doped with Eu as a luminescent center material.

5. The image display apparatus according to claim 4,
wherein the phosphor of a thiogallate crystal comprising an alkaline earth metal and doped with Eu as a luminescent center material is SrGa₂S₄:Eu or (Sr, Ba) Ga₂S₄:Eu.

6. An electronic device, comprising:
the image display apparatus according to claim 1.

7. An electronic device, comprising:
the image display apparatus according to claim 1;
an image information reception circuit that selects desired image information from among a plurality of image information items; and
an image signal generation circuit that generates, on the basis of the selected image information, an image signal that is supplied to the image display apparatus.
